(19) United States
(12) Patent Application Publication
(10) Pub. No.: US 2014/0254394 A1
(43) Pub. Date: Sep. 11, 2014

(54) NETWORK ACTIVATION TESTING

(71) Applicant: CALIX, INC., Petaluma, CA (US)

(72) Inventor: Timothy Hayes, Santa Barbara, CA (US)

(73) Assignee: Calix, Inc., Petaluma, CA (US)

(21) Appl. No.: 13/791,560

(22) Filed: Mar. 8, 2013

(51) Int. Cl. H04L 12/24

(52) U.S. Cl. CPC H04L 41/06
USPC 370/245

(57) ABSTRACT

In general, techniques are described that may allow a network element to autonomously validate a network or network segment. In one example, a method includes configuring a VLAN on a network having at least two network elements, configuring, via a first one of the at least two three network elements on the network, a network loop on the VLAN, generating, via the first one of the at least two network elements on the network, a plurality of data units and injecting the data units onto the network, forwarding, via each of the at least two network elements on the network, the data units around the network loop on the VLAN for a specified time at media speed, configuring one of the at least two network elements on the ring network to stop the network loop, and determining whether there are any network errors.

### TECHNICAL FIELD

The disclosure generally relates to computer networks and, more particularly, to validation techniques.

### BACKGROUND

A computer network is a collection of interconnected computing devices that can exchange data and share resources. Often, in highly populated areas, the computer network is configured in a ring formation, where certain devices, such as layer 2 devices, e.g., a switch, are interconnected via network links in a ring. That is, each layer 2 device couples via a separate network link to two adjacent layer 2 devices, one clockwise and the other counterclockwise around the ring. When arranged in a ring, a network, e.g., an optical fiber network, a copper network, or a combination of both, is referred to as a “ring network.”

### SUMMARY

In general, this disclosure describes techniques that may allow a network element to validate a network, e.g., a ring network, or a network segment on the network without using any external equipment, e.g., a portable network performance analysis device, in order to validate the network before service turn up or following an outage, for example. Service turn up may include physically deploying the equipment, physically interconnecting the ring ports, powering up the equipment, configuring the individual network elements, and enabling the ring ports on the individual nodes, for example. Validating a network before service turn up may help to determine whether there are problem segments, interfaces, fiber modules, and fiber runs, for example, within the network.

Using various techniques described in this disclosure, a network element may inject data units into a loop configured on a network, e.g., an Ethernet ring network, to create a media speed flood scenario such that a validation can be conducted in a short period of time. These techniques may provide a mechanism whereby the network operator does not need a technician with any external equipment to validate a network or network segment. Instead, a network element can autonomously validate a network or network segment before service turn up.

In one example, this disclosure is directed to a method that comprises configuring a virtual local area network (VLAN) on a network having at least two network elements, configuring, via a first one of the at least two three network elements on the network, a network loop on the VLAN, generating, via the first one of the at least two network elements on the network, a plurality of data units and injecting the plurality of data units onto the network, forwarding, via each of the at least two network elements on the network, the plurality of data units around the network loop on the VLAN for a specified time at media speed, configuring one of the at least two network elements on the ring network to stop the network loop, and determining whether there are any network errors based on information related to the forwarded plurality of data units.

In another example, this disclosure is directed to A network element comprising a control unit configured to configure a virtual local area network (VLAN) on a network having at least two network elements, configure a network loop on the VLAN, generate a plurality of data units and inject the plurality of data units onto the network, forward the plurality of data units around the network loop on the VLAN for a specified time at media speed, configure one of the at least two network elements on the ring network to stop the network loop, and determine whether there are any network errors based on information related to the forwarded plurality of data units.

In another example, this disclosure is directed to a computer-readable medium containing instructions. The instructions cause a processor to A computer-readable medium comprising instructions encoded on the computer-readable medium that, upon execution, cause a processor within a network element to configure a virtual local area network (VLAN) on a network having at least two network elements, configure a network loop on the VLAN, generate a plurality of data units and inject the plurality of data units onto the network, forward the plurality of data units around the network loop on the VLAN for a specified time at media speed, configure one of the at least two network elements on the ring network to stop the network loop, and determine whether there are any network errors based on information related to the forwarded plurality of data units.

In this disclosure is directed to a method that comprises configuring a virtual local area network (VLAN) on a first port and a second port of a network element, connecting the first port to the second port, generating, via the network element, a plurality of data units, switching the plurality of data units between the first port and the second port on the VLAN for a specified time, and determining whether there are any errors based on information related to the plurality of packets.

The details of one or more aspects of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example ring network that may implement various techniques described in this disclosure.

FIG. 2 is a block diagram illustrating an example of a network element on the ring network of FIG. 1 that may implement various techniques described in this disclosure.

FIG. 3 is a block diagram illustrating the example network element 12A of FIG. 2 configured to implement various techniques described in this disclosure.

FIG. 4 is a block diagram illustrating an example ring network with a subtended network that may implement various techniques described in this disclosure.

FIG. 5 is a flow chart illustrating an example method of autonomously validating a network or network segment using various techniques of this disclosure.

### DETAILED DESCRIPTION

Ring topologies, e.g., Ethernet ring topologies, are commonly used in networks as they require less optical fiber or copper for connectivity and provide an effective topology for creating a loop-free, layer 2 network with good convergence times. Ring topologies include a number of network elements (or “nodes”) connected such that each network element is connected to two other network elements, thereby forming a ring configuration. Ring topologies require a network element to be configured as a control node to block traffic in order to prevent a traffic loop around the ring network.

For certain types of data that do not include a specific destination, such as multicast or broadcast data, for example, each of the network elements in the ring network may simply forward this data around the ring to ensure that each network element forwards the data to every network element. If none of the network elements detects that this data is looping the ring network, each network element may continue to forward the traffic endlessly, thereby establishing a traffic loop, which may substantially impact the performance of the ring network by needlessly consuming network resources, such as switch processing time and memory as well as link bandwidth.

After physically deploying equipment on the network, e.g., network elements, fiber modules, and fiber runs, it may be desirable to test the equipment and/or network to determine that the equipment and/or network is functioning properly before service turn up (a “validation”). It may also be desirable to revalidate a network (or portion thereof) in response to customer complaints, or to revalidate a network (or portion thereof) following a service outage. Typically, a network activation test involves injecting data units onto the network and gathering error statistics. Such a network activation test, however, is ordinarily a manual process.

Manually performing network activation testing, however, may suffer from one or more disadvantages. For example, a network technician may need to travel to one or more of the network elements on the network. In addition, test equipment external to the network, e.g., a network performance analyzer, may be needed to inject data units to test the network. Also, in order to inject data units via the network element, an extra port on the network element may be needed. Finally, if a problem is found following the manual testing, it may be difficult to determine if the problem is on the network or if there is a problem with the port or the test equipment. In general, this disclosure describes techniques that may allow a network element to validate a network, e.g., a ring network, a network segment on a network, or a network element itself without using any external equipment, e.g., a portable network performance analysis device, in order to validate the network, network segment, or network element before service turn up, for example.

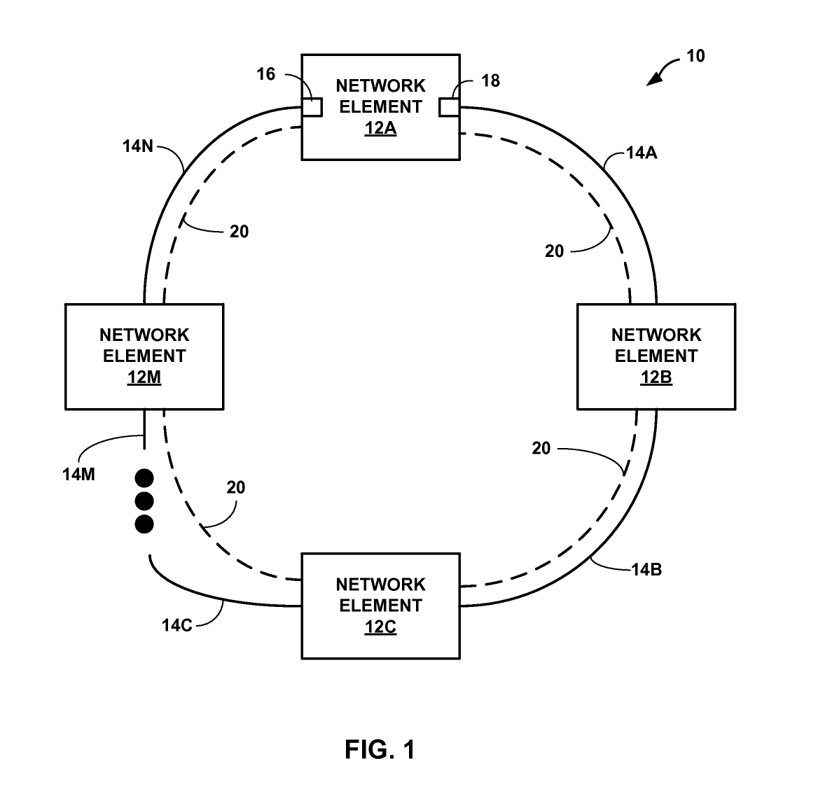

FIG. 1 is a block diagram illustrating an example network, e.g., an Ethernet network, configured to perform a network activation test using various techniques described in this disclosure. As shown in FIG. 1, the simplified ring network 10 includes network elements 12A-12M (“network elements 12”) and links 14A-14N (“links 14”). In one example, the network elements may include the Calix E7-2 Ethernet Service Access Platform. The network elements 12 may be coupled via respective links 14 to form a ring topology. For example, the network element 12A may be coupled to the network element 12B via the link 14A, the network element 12B is coupled to the network element 12C via the link 14B, and so on, completing the ring with the network element 12M coupled to the network element 12A via the link 14N.

In a ring topology, e.g., an Ethernet ring topology, there may be one control node and one or more non-control nodes connected one to another to form a ring. A network operator may designate a network element, e.g., network element 12A, as the control node during creation and deployment of the ring network 10. During normal operation, the control node is responsible for placing a block in the data path of the ring in order to prevent a traffic loop. The control node is also responsible for communicating with non-control nodes, via messaging protocols, on the ring network in order to manage and control ring topology changes.

The network elements 12, e.g., a layer 2 device such as a layer 2 switch, receive and forward traffic from one or more customer devices subtended from the ring network 10 over ring network 10. Each of the network elements 12 may also forward traffic received from other network elements via ring network 10 to one or more customer devices subtended from the ring network 10. For simplicity, any customer devices subtended from the network elements 12 and capable of generating and/or receiving traffic via ring network 10 are not depicted, e.g., personal digital assistants (PDA), workstations, personal computers, laptop computers, television set-top boxes, voice-over-internet protocol (VoIP) telephones, or any other computing devices.

The example ring network 10 may be configured to provide a wide area network (WAN) or a metropolitan area network (MAN). To support a high level of data traffic, the links 14 may comprise optical fiber links to facilitate the rapid transfer of the traffic around ring network 10. However, one or more links 14 may comprise copper wires. In some examples, the ring network 10 may be heterogeneous and comprise both copper and optical media as the links 14. In other examples, the ring network 10 may be homogeneous and comprise only one type of media, e.g., optical fiber or copper, as the links 14.

The ring topology of the ring network 10 may offer geographic coverage and resilience. That is, the ring network 10 may reach customer devices dispersed over wide geographic areas. The ring network 10 may provide resilience because traffic may be forwarded in both a clockwise direction and counterclockwise direction around the ring network 10. By enabling both directions of forwarding, the network elements 12 may forward traffic so as to avoid one of links 14 that has failed, while still reaching every one of the network elements 12.

The network element 12A, acting as a control node, may include a primary port 16 and a secondary port 18. In one implementation, the control node 12A forwards traffic via the primary port 16 and blocks traffic via the secondary port 18 during normal operation in order to correct for traffic loops. A traffic loop may substantially impact the performance of the ring network by needlessly consuming network resources, such as switch processing time and memory as well as link bandwidth. Traffic that is blocked at the secondary port 18 may be discarded so that it is not forwarded through the loop again. Typically, the control node 12A logically blocks the secondary port 18. In other words, the control node 12A may actively filter traffic arriving via the secondary port 18, discarding or dropping certain traffic, such as data traffic, but allowing other traffic, such as control traffic used by the control node 12A to monitor or otherwise control the ring network 10. By blocking traffic arriving via the secondary port 18 in this manner, the control node 12A ensures that data traffic does not continually loop through the ring network 10 during normal operation, while preserving the beneficial aspects of wide geographical coverage and resilience associated with the ring network.

Upon detecting a fault in the link 14A, for example, a control node, e.g., the network element 12A, may forward traffic via the link 14N counterclockwise around the ring network 10 to reach the network element 12B. The network element 12B may, to avoid faulted the link 14A, simultaneously forward traffic via the link 14B clockwise around the ring network 10 to reach the control node, e.g., the network element 12A. The ring network 10 therefore may support simultaneous forwarding of traffic in both the clockwise and counterclockwise directions to avoid the faulted link. Consequently, the ring network 10 may not only provide wide geographical coverage but resilience as well.

Validating a network, e.g., the ring network 10, before service turn up or after a service outage may help to determine whether there are problem segments, interfaces, fiber modules, and fiber runs, for example, within the network. As mentioned above, a network operator typically needs a technician to travel to one or more of the network elements 12 on the network 10 in order to inject data units to test the network 10. For instance, a network operator may need a technician to travel to the location of the network element 12A and inject test data units onto the ring network 10 through an available port on the network element 12A via a network system analyzer. Then, the technician may need to travel to adjacent network element 12B and perform measurements related to the injected data units. In this manner, the technician can test the network elements 12A, 12B and their connecting link 14A.

In accordance with this disclosure and as will be described in more detail below, a network element, e.g., network element 12A, may inject data units on a virtual local area network (VLAN) configured on the ring network 10, e.g., an Ethernet network, to create a media speed flood scenario such that a validation can be conducted in a short period of time. These techniques may provide a mechanism whereby the network operator does not need a technician with any external equipment to validate a network or network segment, e.g., link 14A. Instead, a network element, e.g., network element 12A, can autonomously validate a network or network segment before service turn up. As used in this disclosure, a “data unit” may include packets, frames, blocks, cells, segments, or any other unit of data, depending on the type of network.

Regarding configuring the VLAN on the ring network 10, in some examples, each network element, e.g., network element 12A-12M, configures a virtual local area network (VLAN) 20 that extends around the ring network 10. The VLAN configuration may be accomplished either automatically or manually, e.g., via a network operator manually creating a VLAN on each network element.

In contrast to normal ring network operation, where traffic loops are undesirable, various techniques of this disclosure utilize a traffic loop to continually forward data units around the ring network 10 at media speed, e.g., the speed of the optical fiber or the speed of the copper, until the loop is broken. To that end, the control node of the ring network, e.g., the network element 12A, may unblock the secondary port 18 to configure a traffic loop in the ring network 10 on the VLAN 20.

Once the loop has been created in the ring network 10, the control node, e.g., network element 12A, may begin generating and injecting a plurality of data units onto the ring network 10 for a specified period of time without manual intervention by a network operator. While the data units are forwarded around the ring network 10 on the VLAN 20, each one of network elements 12 may gather information related to the forwarded data units, e.g., transmit and receive errors. After the specified period of time has expired, the control node, e.g., network element 12A, may terminate the traffic loop, e.g., by blocking the secondary port 18. Next, a remotely located computing device and/or one or more of the network elements 12, e.g., the control node 12A, may determine whether there are any network errors based on information related to the forwarded plurality of data units. In this manner, a network element can autonomously validate a network, network segment, and/or network element before service turn up or following a service outage, for example.

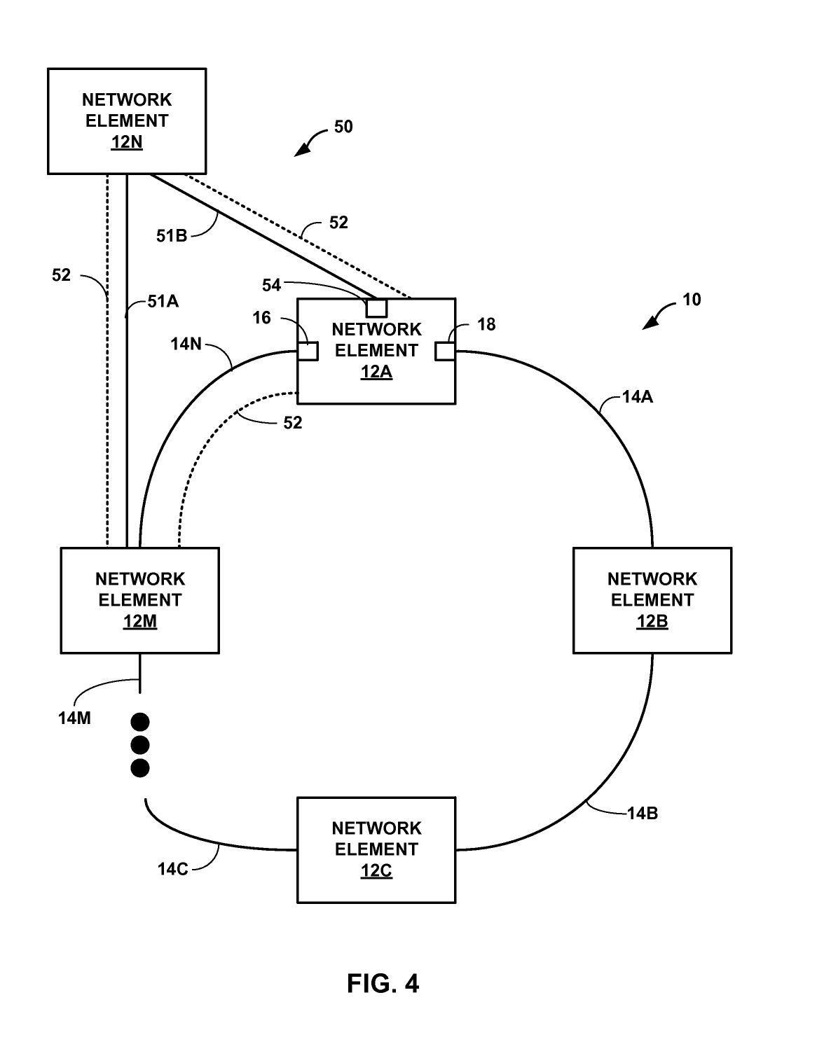

Although the ring network 10 of FIG. 1 depicts at least four network elements 12, the techniques of this disclosure are not limited to such networks. Rather, the techniques of this disclosure can be used to validate networks having only two network elements 12. The techniques of this disclosure can also be used to validate a single network element 12, as described in more detail below with respect to FIG. 3. In addition, the techniques of this disclosure can also be used to validate a network subtended from the main network 10, as described in more detail below with respect to FIG. 4.

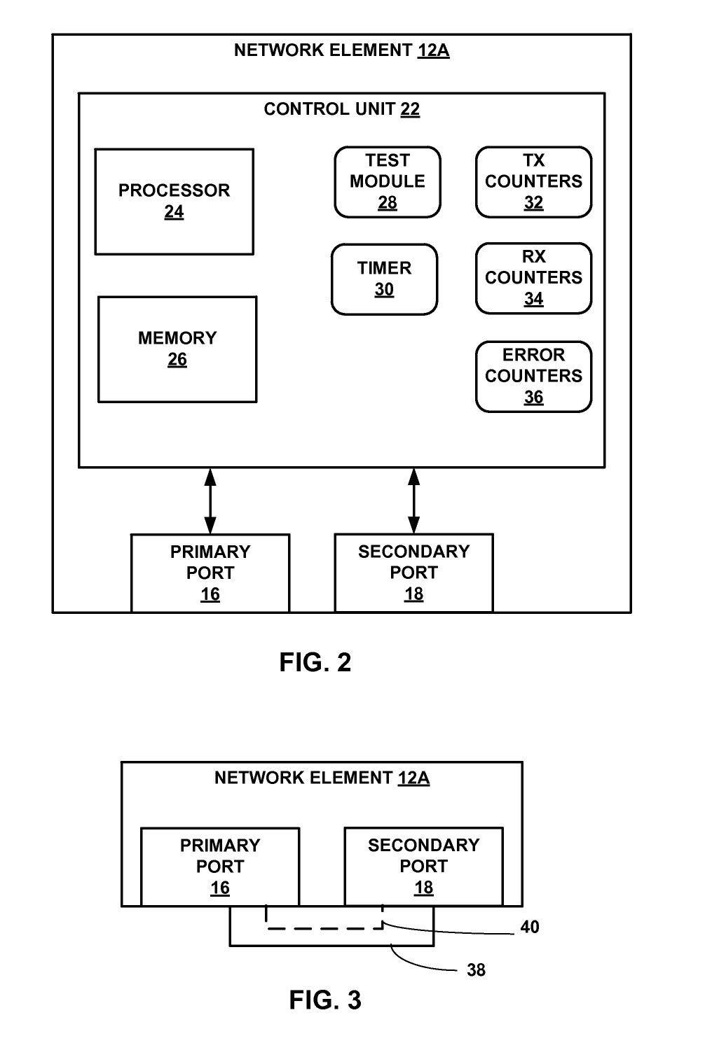

FIG. 2 is a block diagram illustrating, in more detail, an example of the network element 12A shown in FIG. 1 that may implement various techniques described in this disclosure. Although FIG. 2 illustrates the network element 12A, each of network elements 12 may be similarly configured. As shown in FIG. 2, the network element 12A includes the primary port 16 and the secondary port 18, where the primary port 16 interfaces with the link 14N (of FIG. 1) and the secondary port 18 interfaces with the link 14A (of FIG. 1). The primary port 16 and the secondary port 18 are illustrated in this manner merely for exemplary purposes and represent logical designations. That is, currently designated secondary port 18 may be re-designated as a primary port and the primary port 16 may also be re-designated as a secondary port. Although not shown for ease of illustration purposes, the network element 12A may comprise additional ports for receiving additional links 14.

The network element 12A also includes a control unit 22 that couples to the primary port 16 and the secondary port 18. The control unit 22 may comprise one or more processors 24 that execute software instructions, such as those used to define a software or computer program, stored in a computer-readable storage medium such as a memory device 26 (e.g., a Flash memory, random access memory (RAM), or any other type of volatile or non-volatile memory that stores instructions), or a storage device (e.g., a disk drive, or an optical drive). Alternatively, the control unit 22 may comprise dedicated hardware, such as one or more integrated circuits, one or more Application Specific Integrated Circuits (ASICs), one or more Application Specific Special Processors (ASSPs), one or more Field Programmable Gate Arrays (FPGAs), or any combination of the foregoing examples of dedicated hardware, for performing the techniques described in this disclosure.

As seen in FIG. 2, the network element 12A may further include a network activation test module 28 (or “test module 28”) to implement various techniques of this disclosure. In one example, the test module 28 may autonomously validate the network to a specified Bit Error Rate Test (BERT) level, e.g., a BERT test level of 10⁻¹², 10⁻¹³ 10⁻¹⁴, 10⁻¹⁵, etc. Using the techniques of this disclosure, the test module 28 may cause a control unit of a network element, e.g., network element 12A, to configure a VLAN on a ring network. That is, the test module 28 may configure a VLAN, e.g., VLAN 20 of FIG. 1, on the ports 16, 18 of the network element 12A.

Assuming that the network element 12A is the control node of the ring network 10, the test module 28 of the network elements 12A may also generate and transmit to each of the other network elements 12B-12M of the ring network 10 one or more data units comprising profile information in order to configure the VLAN, e.g., VLAN 20 of FIG. 1, on ports of the network elements 12B-12M. Upon receiving the data units, each of the network elements 12B-12M of the ring network 10 may configure the VLAN 20 and forward the data units to an adjacent network element 12 until the VLAN 20 is configured on all the network elements. In other example implementations, the network operator may manually create the VLAN 20 on the ring network 10.

In order to configure a network loop on the ring network 10 for purposes of creating a media speed flood scenario, e.g., so that the network validation test can be conducted in a relatively short period of time, the test module 28 may unblock the secondary port 18. By unblocking the secondary port 18 of the network element 12A, any data units injected onto the ring network 10 may continue to be forwarded around the ring by each of the network elements 12.

Upon configuring the VLAN and the network loop on the ring network 10, the test module 28 may cause the control unit 22 to generate a plurality of data units for the network activation testing, e.g., twenty data units, and to inject the plurality of data units onto the ring network 10 at media speed. Media speed is the maximum load that the medium, e.g., optical fiber or copper, can sustain. Injecting a number of data units into the loop results in media speed forwarding of the injected data units. By way of comparison, optical fiber is generally able to sustain a higher speed of transmission of data units than copper.

In one example implementation, the test module 28 can cause the control unit 22 to generate relatively large data units, e.g., 16 kilobytes. It may be desirable to generate and inject data units that are the largest size supported by every network element on the network in order to reduce the amount of time needed to produce a specified BERT level. Smaller data units can cause gaps, e.g., inter-packet gaps, that can during which no testing occurs, e.g., dead time. In some examples, the data units may be the same size as one another. In other examples, the data units may be different sizes.

In some example implementations, the test module 28 may cause the control unit 22 to generate the plurality of data units for network activation testing such that the data units have varying data patterns. The use of varying data patterns may help exercise the circuitry of the network elements 12 of the ring network, which, in turn, may expose potential issues or vulnerabilities with the network. In one example, the test module 28 may randomly generate the data patterns.

As seen in FIG. 2, the control unit 22 may further include a timer 30 for validating the network 10 to the BERT test level specified by the network operator, e.g., a BERT test level of 10⁻¹², 10⁻¹³ 10⁻¹⁴, 10⁻¹⁵, etc. By way of example, it may take 1.5 minutes to validate a 10 Gigabit network to a BERT test level of 10⁻¹² and take 15 minutes to validate a 1 Gigabit network to the same BERT test level. Once the test module 28 injects the plurality of data units onto the ring network 10, the test module 28 sets the timer 30 for a specified time based on the desired BERT test level, e.g., 15 minutes to validate a 1 Gigabit network to a BERT test level of 10⁻¹², and then starts the timer 30.

Each of the network elements on the ring network, e.g., network elements 12A-12M, forward the plurality of data units around the ring on the VLAN 20 for the specified time e.g., 15 minutes. For a heterogeneous ring, e.g., a ring network 10 that includes both optical fiber links 14 and copper links 14, the effect is that the slower link, e.g., copper, regulates the actual rate of flow of the plurality of data units. For example, for a 10 Gigabit network with a 1 Gigabit segment, the test module 28 can conduct a 1 Gigabit test based on the effective rate around the ring network.

In one example implementation, instead of testing the ring network 10 at media speed, the test module 28 may test at a pseudo-media speed, where the pseudo-media speed is the media speed of a rate limited network, e.g., to test a live network. That is, the test module 28 may establish rate limiting on the configured test VLAN 20. For example, the test module 28 may establish a 10 Megabit loop on the VLAN 20 that is running continuously on a 10 Gigabit ring network 10.

In one example implementation, the test module 28 may define a priority level for the plurality of data units injected onto the ring network 10 for network validation. For example, the test module 28 may assign a lower priority to the plurality of data units used for network validation than that which the control unit 22 assigns to the data units used to communicate with the other network elements in the ring network 10. By assigning a lower priority to the data units used for network validation and a higher priority to communication data units between network elements, the control node 12A may be able to communicate with all the other network elements 12B-12M despite the saturation of the ring network 10 during testing.

It should be noted that the techniques of this disclosure are not limited to any particular ring protocol. As such, the techniques of this disclosure may be implemented using ring protocols that include, but are not limited to, Rapid Ring Protection Protocol, Resilient Ethernet Protocol, IEEE 802.17 Resilient Packet Ring Protocol, and RFC-3619. As one example implementation, the techniques of this disclosure may run in parallel with a ring protection protocol by configuring a VLAN on the ring and a loop on the VLAN in the manner described above.

As mentioned above, the test module 28 sets the timer 30 for a specified time based on the desired BERT test level, e.g., 15 minutes to validate a 1 Gigabit network to a BERT test level of 10⁻¹², and then starts the timer 30. Once the timer 30 reaches the specified time, the BERT test to the desired BERT test level is complete. In order to break the network loop, the test module 28 can block the secondary port 18 of the network element 12A. By blocking the secondary port 18 of the network element 12A, any data units injected onto the ring network 10 will be prevented from being forwarded around the ring.

One or more of the network elements 12 of the ring network 10 may gather statistics based on information related to the plurality of data units forwarded around the ring network 10 for the network validation testing. To that end, one or more network elements 12 may count the number the number of data units transmitted (TX), the number of data units received (RX), and count errors that may occur during the testing. For example, the network element 12A may include TX counters 32 that count the number the number of data units transmitted, RX counters 34 that count the number the number of data units received, and error counters 36 that count errors, e.g., Frame Check Sequence (FCS) errors, Cyclic Redundancy Check (CRC) errors, jabber errors, runt errors, “too-long” errors, and the like. Using the counter information from the TX counters 32, RX counters 34, and the error counters 36, one or more of the network elements 12 (or a device located remotely from the ring network 10) may determine whether there are any network errors.

In one example implementation, each network element 12 of the ring network may determine whether there are any network errors by comparing TX counters 32 and RX counters. Desirably, the TX counters 32 match the RX counters 34, indicating that all of the transmitted data units were received.

If the error counters 36 are zero (indicating that there were no errors detected), but the TX counters 32 and the RX counters 34 do not match one another, then one or more data units were lost during the testing. For example, a preamble may have been damaged and, as a result, a receiving network element 12 was not able to synchronize on the incoming signal.

If, for example, the TX counters 32 and the RX counters 34 of the control node, e.g., the network element 12A, match one another, then the ring network 10 has no issues. If the TX counters 32 and the RX counters 34 on the control node do not match, then a point-to-point analysis on each network element 12 of the ring network 10 may be needed to determine the problem, e.g., whether the problem is a network element 12 or a link 14.

As indicated above, in some examples, one of the network elements, e.g., the control node, can determine whether there are any network errors based on information related to the forwarded plurality of data units. In other examples, the network elements can gather the information related to the forwarded plurality of data units, e.g., the TX counter information, the RX counter information, and the error counter information, and relay that information to a remote device, e.g., a device that is not part of the ring network 10, to determine whether there are any network errors. For example, the information can be relayed to a network management system (not depicted) that may determine whether there are any network errors.

In this manner, a network element can autonomously validate a network before service turn up. As mentioned above, autonomously validating a network using the techniques described above may advantageously reduce the need for external test equipment and technicians to test the network, and may improve the diagnostics of the network by reducing the number of variables if a problem is found, e.g., a port on a network element or the external test equipment.

Although the validation techniques of this disclosure were described above with respect to a network, the techniques of this disclosure are not so limited. As shown and described in more detail below with respect to FIG. 3, the techniques of this disclosure may also be applied to a single network element, e.g., the network element 12A of FIG. 2.

FIG. 3 is a block diagram illustrating the example network element 12A of FIG. 2 configured to implement various techniques described in this disclosure. In FIG. 3, the network element 12A is similar to the network element 12A depicted in FIG. 2 and, for purposes of conciseness, will not be described in detail again.

To test a single network element, e.g., the network element 12A, a first port is connected to a second port. For example, in FIG. 3, the primary port 16 is connected via a link 38 to the secondary port 18. A test module 28 (or a network operator) can figure a VLAN, e.g., VLAN 40, on the primary and secondary ports 16, 18.

Upon configuring the VLAN and the network loop on the ring network 10, the test module 28 may cause the control unit 22 to generate a plurality of data units for the network activation testing, e.g., twenty data units, and to switch the plurality of data units out one of the ports, e.g., the primary port 16. Because the ports 16, 18 are members of the same VLAN, e.g., VLAN 40, the data units received by port 18 via link 38 is carried through the switch fabric of the network element 12A and transmitted back out the port 16. In this manner, the network element 12A is looped back onto itself.

As mentioned above, the test module 28 sets the timer 30 for a specified time based on the desired BERT test level, e.g., 15 minutes to validate a 1 Gigabit network element to a BERT test level of 10⁻¹², and then starts the timer 30. Once the timer 30 reaches the specified time, the BERT test to the desired BERT test level is complete. In order to break the network loop, the test module 28 may remove the VLAN 20, which may prevent data units received by port 18 from being switched out port 16. In other example configurations, it is also possible to break the network loop using one or more of the following techniques: configuring the VLAN 20 to be in a “blocking” state, configuring a filter to drop the VLAN 20 data units, and placing the port on which the VLAN 20 is configured to drop all data units.

As indicated above, the network element 12A may include the TX counters 32 that count the number the number of data units transmitted, the RX counters 34 that count the number the number of data units received, and the error counters 36 that count errors, e.g., Frame Check Sequence (FCS) errors, Cyclic Redundancy Check (CRC) errors, jabber errors, runt errors, “too-long” errors, and the like. Using the counter information from the TX counters 32, the RX counters 34, and the error counters 36, the network element 12A can determine whether there are any errors. In this manner, a network element can autonomously validate itself before service turn up, for example.

FIG. 4 is a block diagram illustrating an example ring network with a subtended network that may implement various techniques described in this disclosure. More particularly, FIG. 4 depicts a main ring network 10 that includes network elements 12A-12M and a subtended ring network 50 that includes network elements 12A, 12M, and 12N connected by links 14N, 51A, and 51B. In some examples, the main ring network 10 may be an existing, live network and subtended network 50 may be a later-added network that the network operator would like to ensure is functioning properly before service turn up, for example.

Either one or both of the network 10 and the subtended network 50, or a portion of either, may be validated using the techniques of this disclosure. Validation of the ring network 10 was described above and, for purposes of conciseness, will not be described in detail again.

The subtended network 50 may be validated in a manner similar to that described above with respect to the ring network 10. In some examples, the network element 12A may act as a control node for both the ring network 10 and the subtended network 50. In other examples, the ring network 10 and the subtended network 50 may each have their own control node, e.g., the network element 12A as the control node for the network 10 and the network element 12N as the control node for the subtended network 50.

Similar to what was described above, a network element, e.g., network element 12A, may inject data units on a virtual local area network (VLAN) configured on the subtended network 50, e.g., an Ethernet network, to create a media speed flood scenario such that a validation may be conducted in a short period of time. In this manner, the network element may autonomously validate a network or network segment before service turn up.

Regarding configuring the VLAN on the subtended network 50, in some examples, each network element, e.g., network element 12A, 12M, and 12N may configure a VLAN 52 that extends around the subtended network 50. The VLAN configuration may be accomplished either automatically or manually, e.g., via a network operator manually creating a VLAN on each network element. An example method of automatic VLAN configuration was described above and, for purposes of conciseness, will not be described again.

To create a network loop, the control node of the subtended network, e.g., the network element 12A, may unblock the port 54 to configure a loop in the subtended network 50 on the VLAN 52. Once the loop has been created in the subtended network 50, the control node, e.g., network element 12A, may begin generating and injecting a plurality of data units onto the subtended network 50 for a specified period of time. While the data units are forwarded around the subtended network 50 on the VLAN 52, each one of network elements 12A, 12M, and 12N may gather information related to the forwarded data units, e.g., transmit and receive errors.

After the specified period of time has expired, the control node, e.g., network element 12A, may terminate the network loop, e.g., by blocking the port 54. Next, a remotely located computing device and/or one or more of the network elements 12, e.g., the control node 12A, may determine whether there are any network errors based on information related to the forwarded plurality of data units.

As indicate above, the network element 12A may include the TX counters 32 that count the number the number of data units transmitted, the RX counters 34 that count the number the number of data units received, and the error counters 36 that count errors, e.g., Frame Check Sequence (FCS) errors, Cyclic Redundancy Check (CRC) errors, jabber errors, runt errors, “too-long” errors, and the like. Using the counter information from the TX counters 32, the RX counters 34, and the error counters 36, the network element 12A (or a remote network management system) may determine whether there are any errors. In this manner, a network element can autonomously validate a subtended network before service turn up, for example.

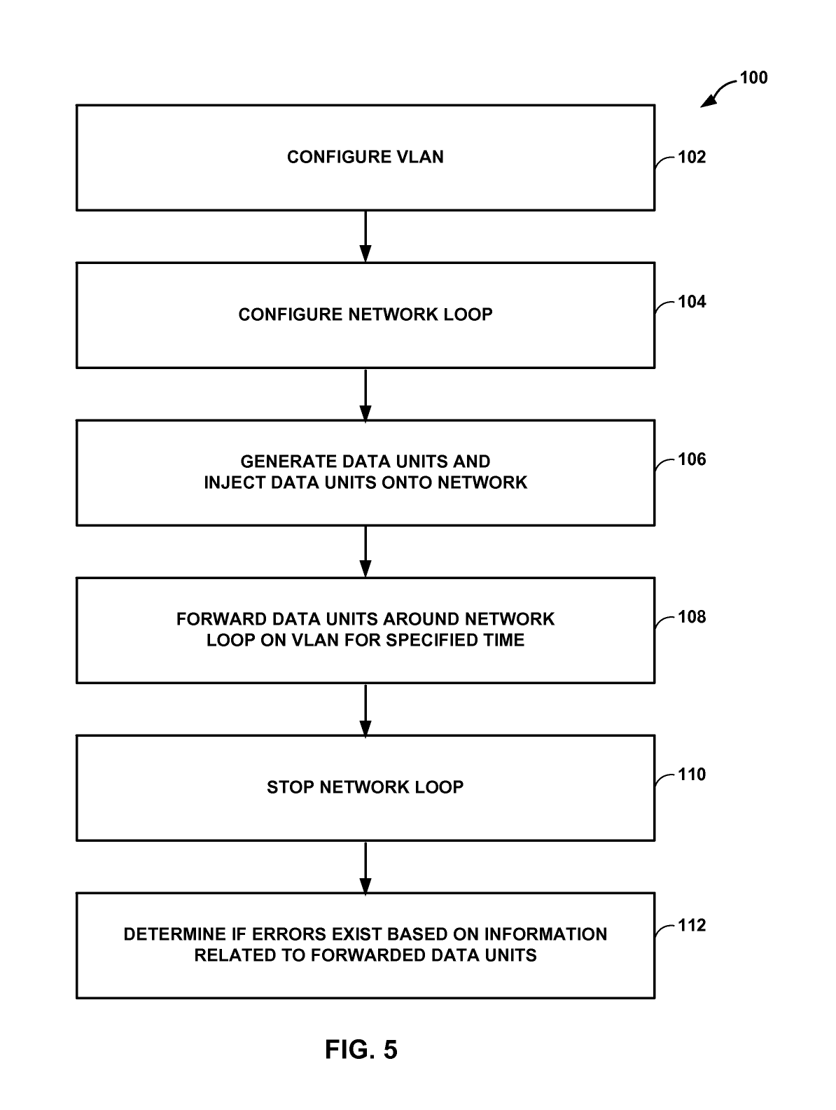

FIG. 5 is a flow chart illustrating an example method of autonomously validating a network or network segment using various techniques of this disclosure. In the example method of FIG. 5, shown generally at 100, a network operator or network element 12, can configure a VLAN on a network having at least two network elements (102), e.g., VLAN 20 of FIG. 1. The network element 12 can also configure a network loop, e.g., by unblocking a port on a control node (104). The control unit 22 of the network element, e.g., network element 12A, generates a plurality of data units and injects the data units onto the network (106). Each of the network elements 12 of the network forward the data units around the network loop on the VLAN for a specified period of time (108), e.g., as determined by a desired BERT test level, at media speed.

After the specified period of time, one of the network elements stops the network loop, e.g., by blocking a port on a control node (110). One or more of the network elements 12 of the network may gather statistics based on information related to the plurality of data units forwarded around the network for the network validation testing. Using the counter information from the TX counters 32, RX counters 34, and the error counters 36, for example, one or more of the network elements 12 (or a device located remotely from the ring network 10) can determine whether there are any network errors.

It should be noted that although the techniques of this disclosure were described above with respect to wired configurations, e.g., optical or copper, the techniques of this disclosure may also be applied to wireless networks.

The techniques described in this disclosure may be implemented, at least in part, in hardware, software, firmware or any combination thereof. For example, various aspects of the described techniques may be implemented within one or more processors, including one or more microprocessors, digital signal processors (DSPs), network processors (NPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate computing hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples of the disclosure have been described. These and other examples are within the scope of the following claims.

1. A method comprising:
configuring a virtual local area network (VLAN) on a network having at least two network elements;
configuring, via a first one of the at least two network elements on the network, a network loop on the VLAN;
generating, via the first one of the at least two network elements on the network, a plurality of data units and injecting the plurality of data units onto the network;
forwarding, via each of the at least two network elements on the network, the plurality of data units around the network loop on the VLAN for a specified time at media speed;
configuring one of the at least two network elements on the ring network to stop the network loop; and
determining whether there are any network errors based on information related to the forwarded plurality of data units.

2. The method of claim 1, wherein generating, via the first one of the at least two network elements on the network, a plurality of data units is without manual intervention.

3. The method of claim 1, wherein the plurality of data units is assigned a first priority level and wherein the at least two network elements on the network are configured to communicate with each other using a second priority level.

4. The method of claim 3, wherein the first priority level is lower than the second priority level.

5. The method of claim 1, wherein the network is an Ethernet network.

6. The method of claim 1, wherein each of the plurality of data units has a size equal to the maximum size supported by each of the at least two network elements on the network.

7. The method of claim 6, wherein each of the plurality of data units comprises a different data pattern.

8. The method of claim 1, wherein determining whether there are any network errors based on information related to the forwarded plurality of data units comprises:
comparing transmit counters and receive counters.

9. The method of claim 1, wherein the plurality of data units comprises a plurality of packets.

10. The method of claim 9, wherein determining whether there are any network errors based on information related to the forwarded plurality of data units comprises: determining at least one of a Frame Check Sequence (FCS) error, Cyclic Redundancy Check (CRC) error, a jabber error, a runt error, and a packet too long error.

11. A network element comprising a control unit configured to:
configure a virtual local area network (VLAN) on a network having at least two network elements;
configure a network loop on the VLAN;
generate a plurality of data units and inject the plurality of data units onto the network;
forward the plurality of data units around the network loop on the VLAN for a specified time at media speed;
configure one of the at least two network elements on the ring network to stop the network loop; and
determine whether there are any network errors based on information related to the forwarded plurality of data units.

12. The network element of claim 11, wherein the control unit is configured to generate the plurality of data units without manual intervention.

13. The network element of claim 11, wherein the plurality of data units is assigned a first priority level and wherein the at least two network elements on the network are configured to communicate with each other using a second priority level.

14. The network element of claim 13, wherein the first priority level is lower than the second priority level.

15. The network element of claim 11, wherein the network is an Ethernet network.

16. The network element of claim 11, wherein each of the plurality of data units has a size equal to the maximum size supported by each of the at least two network elements on the network.

17. The network element of claim 16, wherein each of the plurality of data units comprises a different data pattern.

18. The network element of claim 11, wherein the control unit configured to determine whether there are any network errors based on information related to the forwarded plurality of data units is configured to:
compare transmit counters and receive counters.

19. The network element of claim 11, wherein the plurality of data units comprises a plurality of packets.

20. The network element of claim 19, wherein the control unit configured to determine whether there are any network errors based on information related to the forwarded plurality of data units is further configured to:
determine at least one of a Frame Check Sequence (FCS) error, Cyclic Redundancy Check (CRC) error, a jabber error, a runt error, and a packet too long error.

21. A computer-readable medium comprising instructions encoded on the computer-readable medium that, upon execution, cause a processor within a network element to:
configure a virtual local area network (VLAN) on a network having at least two network elements;
configure a network loop on the VLAN;
generate a plurality of data units and inject the plurality of data units onto the network;
forward the plurality of data units around the network loop on the VLAN for a specified time at media speed;
configure one of the at least two network elements on the ring network to stop the network loop; and
determine whether there are any network errors based on information related to the forwarded plurality of data units.

22. The computer-readable medium of claim 21, wherein the instruction to cause the processor to generate the plurality of data units is without manual intervention.

23. The computer-readable medium of claim 21, wherein the plurality of data units is assigned a first priority level and wherein the at least two network elements on the network are configured to communicate with each other using a second priority level.

24. The computer-readable medium of claim 23, wherein the first priority level is lower than the second priority level.

25. The computer-readable medium of claim 21, wherein the network is an Ethernet network.

26. The computer-readable medium of claim 21, wherein each of the plurality of data units has a size equal to the maximum size supported by each of the at least two network elements on the network.

27. The computer-readable medium of claim 26, wherein each of the plurality of data units comprises a different data pattern.

28. The computer-readable medium of claim 21, wherein the control unit configured to determine whether there are any network errors based on information related to the forwarded plurality of data units is configured to:
compare transmit counters and receive counters.

29. The computer-readable medium of claim 21, wherein the plurality of data units comprises a plurality of packets.

30. The computer-readable medium of claim 29, wherein the instruction to cause the processor to determine whether there are any network errors based on information related to the forwarded plurality of data units comprises the instruction to:
determine at least one of a Frame Check Sequence (FCS) error, Cyclic Redundancy Check (CRC) error, a jabber error, a runt error, and a packet too long error.

31. A method comprising:
configuring a virtual local area network (VLAN) on a first port and a second port of a network element;
connecting the first port to the second port;
generating, via the network element, a plurality of data units;
switching the plurality of data units between the first port and the second port on the VLAN for a specified time; and
determining whether there are any errors based on information related to the plurality of packets.
